(19) United States
(12) Patent Application Publication
(10) Pub. No.: US 2005/0152110 A1
(43) Pub. Date: Jul. 14, 2005

(54) Portable raid device

(76) Inventor: Winston Chen, Irvine, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/756,536

(22) Filed: Jan. 13, 2004

(51) Int. Cl. G06F 1/16

(52) U.S. Cl. 361/685

(57) ABSTRACT

A portable RAID device has four hard disk drives and a RAID controller within an enclosure. The RAID controller controls the RAID array according to at least RAID level 5. The portable RAID device has an input/output port configured to connect the portable RAID device to a computer, such that the portable RAID device provides reliable, RAID-compliant external storage that may be moved from computer to computer. Input/output connectors on each hard disk drive face inward toward the middle of the enclosure along one dimension. The four hard disk drives are arranged in a compact 2 by 2 pattern. The space efficient layout of the portable RAID device allows the device to house a four hard disk drive RAID array within a rectangular enclosure with roughly the same dimensions as a laptop computer.

### BACKGROUND OF THE INVENTION

1. Field of the Invention

Aspects of the invention are related generally to portable data storage, or data storage that may be moved from one computer to another.

2. Description of the Related Art

In a Redundant Array of Inexpensive Disks (“RAID”) system, a single RAID controller controls multiple hard disk drives. The typical purpose of such an arrangement is to enhance reliability of data storage by providing data striping, data mirroring, duplexing, parity checking, and other techniques for enhancing reliability of data storage. Several RAID levels have been defined, with each level using one or more technique for enhancing data reliability. Some of these RAID levels, known to skilled artisans, are RAID levels 0, 1, 2, 3, 4, 5, 6, 7, 10, 53, and 0+1.

Of the foregoing RAID levels, all but RAID levels 0 and 1 require more than two hard drives. Most RAID arrays have been implemented in the form of towers, essentially with hard disk drives stacked on top of each other. Because of their typical configuration and other factors, RAID arrays have typically been bulky. For this and other reasons, RAID arrays have typically been confined to desktop and server computers. Because of these constraints, external RAID systems are typically either too bulky or cumbersome to be truly portable or do not support more than two hard disk drives. As will be appreciated by a skilled artisan, a RAID array with only two hard drives cannot support RAID levels other than levels 0 and 1. RAID levels 0 and 1 may not provide sufficient redundancy or performance for some applications. RAID level 0 is not as fault-tolerant as other RAID levels and is not considered sufficient for mission critical applications. RAID level 1 requires more disk overhead than other RAID levels and is therefore relatively inefficient.

### SUMMARY OF THE INVENTION

The portable RAID device described herein provides four hard disk drives and a RAID controller within an easy-to-handle and truly portable enclosure. The enclosure has roughly the shape and dimensions of a laptop computer. Advantageously, these dimensions allow a user to carry both a laptop computer and the portable RAID device easily in a single carrying case. Furthermore, the portable RAID device may fit nicely under a laptop computer while the laptop computer is in use. Additionally, the portable RAID device may connect easily to any computer through standard connections such as firewire connections, USB connections, and the like. As such, the portable RAID device may be disconnected from one computer and connected to another computer easily and at any time. Moreover, the portable RAID device achieves its portability while providing full support for at least RAID level 5.

A skilled artisan will appreciate, in light of the detailed description that will shortly follow, how each aspect of the layout of the portable RAID device, in its various embodiments described herein, allows the portable RAID device to achieve one or more of the foregoing advantages. A skilled artisan will further appreciate, from this disclosure, other modifications that can be made to the embodiments disclosed herein without departing from the principles of the invention. Neither this summary nor the following detailed description purports to define the invention. Only the claims define the invention.

### BRIEF DESCRIPTION OF THE DRAWINGS

FIG. 1 illustrates an open portable RAID device according to one embodiment.

FIG. 2 illustrates an arrangement of hard disk drives within the enclosure of the portable RAID device according to one embodiment.

FIG. 3 illustrates positioning of a RAID controller within the enclosure of the portable RAID device according to one embodiment.

FIG. 4 illustrates the rear of the closed portable RAID device according to one embodiment.

FIG. 5 shows a laptop computer resting on top of the closed portable RAID device according to one embodiment.

FIG. 6 is a diagram showing the portability of the portable RAID device according to one embodiment.

### DETAILED DESCRIPTION OF THE PREFERRED EMBODIMENT

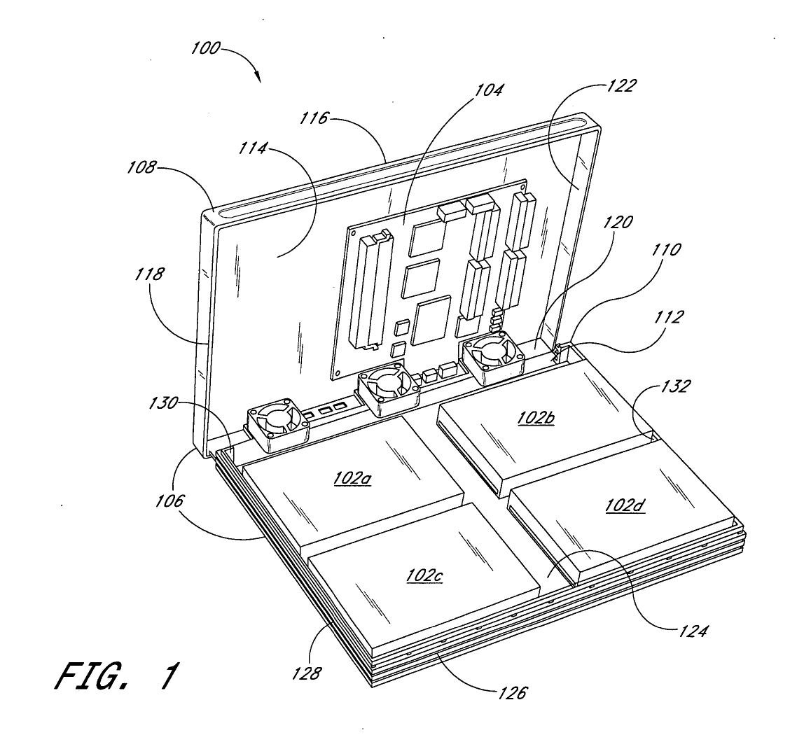

FIG. 1 illustrates a portable RAID device 100 according to one embodiment. The portable RAID device 100 supports four hard drives 102a through 102d in communication with a RAID controller 104. The hard drives 102a through 102d may be full-capacity, standard form factor, hard drives, such as IDE drives, Serial ATA drives, or SCSI drives. Indeed, any hard drive known to a skilled artisan to be compatible with RAID may be employed. According to typical drive capacities known as of this disclosure, the portable RAID device 100 may store a vast amount of data, including up to 300 Gigabytes of data per hard drive. It is anticipated, however, that hard drive capacities will continue to increase, such that the capacity of the portable RAID device 100 according to the architecture of this disclosure will likely increase. The RAID controller 104 may be configured to support one or more of RAID levels 0, 1, 3, 5, and 10. In one preferred embodiment, the RAID controller 104 is configured to support RAID level 5. In light of the foregoing, a skilled artisan will appreciate that the portable RAID device 100 is a fully-functional four drive RAID device. Thus, the portable RAID device 100 has an advantage over two drive portable RAID devices, as those RAID devices may support RAID levels 0 and 1 only.

Furthermore, as a skilled artisan will appreciate from the illustration and this disclosure, the portable RAID device 100 has advantageous layout, shape, and dimensions. The hard drives 102a through 102d may be arranged in a 2×2 grid pattern as shown. In the 2×2 grid pattern shown, the hard drives 102a through 102d are positioned side-by-side with respect to a horizontal plane, not on top of each other as in a tower configuration. The portable RAID device 100 may be advantageously shaped and dimensioned similarly to a laptop computer. The dimensions and shape of the portable RAID device 100 advantageously allow a user to easily transport the device and access its data even if the user changes computers. For example, a user may disconnect the portable RAID device 100 from his or her office computer and easily connect it to his or her home computer. Additionally, a user may easily connect the portable RAID device 100 to his or her laptop computer. The portable RAID device 100 achieves all of these advantages of portability, while still maintaining a vast data storage capacity and support for RAID levels 0, 1, 3, 5, and 10.

Both the hard drives 102a through 102d and the RAID controller 104 are secured to and encased within an enclosure 106. As illustrated, the enclosure 106 may be opened so as to allow a user to access internal components of the portable RAID device 100. Thus, a user may, for example, replace one or more of the hard drives 102a through 102d should it become necessary. Alternatively, the enclosure 106 may be closed to protect the internal components. Additionally, the enclosure 106 provides surfaces upon which the internal components are secured. A skilled artisan will appreciate that the enclosure 106 may be built from any number of materials that would enable the enclosure 106 to perform its functions. Typically, such materials may include plastics, aluminum or other metals, or any combination of plastics and metals. Advantageously, the materials may be lightweight yet durable enough to protect the internal components.

The enclosure 106 comprises a top shell 108, a bottom shell 110, and a hinge 112. The top shell 108 comprises a top mounting surface 114, a top front wall 116, a top left wall 118, a top back wall 120, and a top right wall 122. The bottom shell 110 comprises a bottom mounting surface 124, a bottom front wall 126, a bottom left wall 128, a bottom back wall 130, and a bottom right wall 132. The hinge 112 connects to the top back wall 120 and the bottom back wall 130 such that the top back wall 120 and the bottom back wall 130 may be rotated with respect to each other. As such, the enclosure 106 may assume an open position, as shown, or a closed position. In a closed position, the hinge 112 is vertical and aligned in parallel with the top back wall 120 and the bottom back wall 130, the top front wall 116 abuts and extends vertically above the bottom front wall 126, the top left wall 118 abuts and extends vertically above the bottom left wall 128, the top back wall 120 abuts and extends vertically above the bottom back wall 130, the top right wall 122 abuts and extends vertically above the bottom right wall 132, and the top mounting surface 114 is substantially parallel to the bottom mounting surface 124. Thus, in a closed position, the enclosure 106 essentially is sealed and protected from the elements.

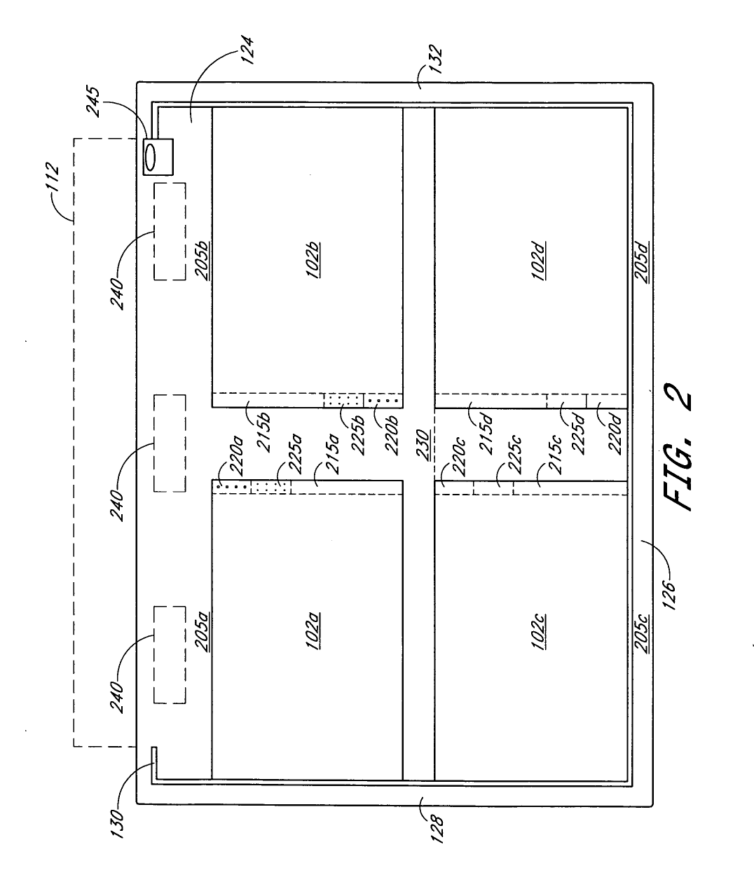

FIG. 2 illustrates in greater detail the layout of the four hard drives 102a through 102d within the bottom shell 110 according to one embodiment. The hard drives 102a through 102d are secured to the bottom mounting surface 124, which comprises a generally flat platform upon which components may be positioned and secured. For ease of reference, the bottom mounting surface 124 may be logically divided into four quadrants, an upper left quadrant 205a, an upper right quadrant 205b, a lower left quadrant 205c, and a lower right quadrant 205d. An upper left hard drive 102a may be secured to the bottom mounting surface 124 within the upper left quadrant 205a. An upper right hard drive 102b may be secured to the bottom mounting surface 124 within the upper right quadrant 205b. A lower left hard drive 102c may be secured to the bottom mounting surface 124 within the lower left quadrant 205c. A lower right hard drive 102d may be secured to the bottom mounting surface 124 within the lower right quadrant 205d.

Each hard drive 102a through 102d is connected to the RAID controller 104 by a controller connection 215a, through 215d. Each hard drive 102a through 102d receives power through a power connection 220a through 220d. Each hard drive 102a through 102d may have a set of jumpers 225a through 225d for configuring each hard drive. Typically, the jumpers 225a through 225d are set such that each hard drive 102a through 102d is configured to be a master hard drive.

Three fans 240 (also shown in FIG. 1) are secured to the hinge 112 such that when the enclosure 106 is closed, the fans 240 are moved into the position illustrated in dashed lines on FIG. 2. When the enclosure 106 is closed, the fans 240 are positioned near the upper edge of the bottom mounting surface 124 such that they may blow air across the inside of the enclosure 106 and its internal components, including the hard drives 102a through 102d. While the fans 240 are typically secured to the hinge 112, they also may be secured directly to the bottom mounting surface 124 at the position shown by the dashed lines. A different number of fans may be employed, though three should be adequate to maintain an appropriate operating temperature for the portable RAID device 100. In one embodiment, as illustrated, the fans 240 are arranged such that one fan is located at or near a central location along an edge of the hard drive 102a, one fan is located at or near a central location along an edge of the hard drive 102b, and one fan is located at or near a central location between the hard drive 102a and the hard drive 102b. Advantageously, this configuration of the fans 240 is capable of dissipating heat from significant sources of heat, such as,for example, the bottom of the hard drives 102a through 102b and the RAID controller 104.

A power port 245 is secured to the upper edge of the bottom mounting surface 124, near the hinge 112. An opening may be formed through the hinge 112 to allow access to the power port 245 while the enclosure 106 is closed. The power port 245 receives power from an external source. The power port 245 then transmits power to the hard drives 102a through 102d, the RAID controller 104, and the fans 240, using standard power cables known to a skilled artisan.

As illustrated, the upper left hard drive 102a is positioned within a short distance, such as, for example, 0.25 inches, 0.50 inches, between 0.10 inches and 1.0 inch, or between 0.20 inches and 0.80 inches, or between 0.30 inches and 0.60 inches, from the bottom left wall 128. The upper left hard drive 102a may be positioned a larger distance from the bottom back wall 130 to allow room for the fans 240 when the portable RAID device 100 is closed. Nevertheless, the upper left hard drive 102a is advantageously positioned within a short distance from the nearest edge of the fans 240, such as for example, 0.25 inches, 0.50 inches, between 0.10 inches and 1.0 inch, or between 0.20 inches and 0.80 inches, or between 0.30 inches and 0.60 inches. The controller connector 115a of the upper left hard drive 102a faces inward, toward the middle of the bottom mounting surface 124.

As illustrated, the upper right hard drive 102b is positioned to the right and substantially parallel with the upper left hard drive 102a and within a short distance, such as, for example, 0.25 inches, 0.50 inches, between 0.10 inches and 1.0 inch, or between 0.20 inches and 0.80 inches, or between 0.30 inches and 0.60 inches, from both the bottom right wall 132 and the nearest edge of the fans 240. The controller connector 115b of the upper right hard drive 102b faces inward, toward the middle of the bottom mounting surface 124.

As illustrated, the lower left hard drive 102c is positioned in front of and substantially parallel with the upper left hard drive 102a and within a short distance, such as, for example, 0.25 inches, 0.50 inches, between 0.10 inches and 1.0 inch, or between 0.20 inches and 0.80 inches, or between 0.30 inches and 0.60 inches, from both the bottom left wall 128 and the bottom front wall 126. Advantageously, the lower left hard drive 102c is also placed a short distance, such as, for example, 0.25 inches, 0.50 inches, between 0.10 inches and 1.0 inch, or between 0.20 inches and 0.80 inches, or between 0.30 inches and 0.60 inches, from the lower edge of the upper left hard drive 102a. The controller connector 115c of the lower left hard drive 102c faces inward, toward the middle of the bottom mounting surface 124.

As illustrated, the lower right hard drive 102d is positioned to the right and substantially parallel with the lower left hard drive 102d and within a short distance, such as, for example, 0.25 inches, 0.50 inches, between 0.10 inches and 1.0 inch, or between 0.20 inches and 0.80 inches, or between 0.30 inches and 0.60 inches, from both the bottom front wall 126 and the bottom right wall 132. Advantageously, the lower right hard drive 102d may also be placed a short distance, such as, for example, 0.25 inches, 0.50 inches, between 0.10 inches and 1.0 inch, or between 0.20 inches and 0.80 inches, or between 0.30 inches and 0.60 inches, from the lower edge of the upper right hard drive 102b. The controller connector 115d of the lower right hard drive 102d faces inward, toward the middle of the bottom mounting surface 124.

As illustrated, the positioning of the hard drives 102a through 102d leaves a gap 230 of approximately 1.5 inches across running from the bottom front wall 126 to the bottom back wall 130. Alternatively, the gap 230 may be approximately 0.75 inches, 1.0 inch, 1.25 inches, 1.75 inches, 2.0 inches, or more than 2.0 inches, across.

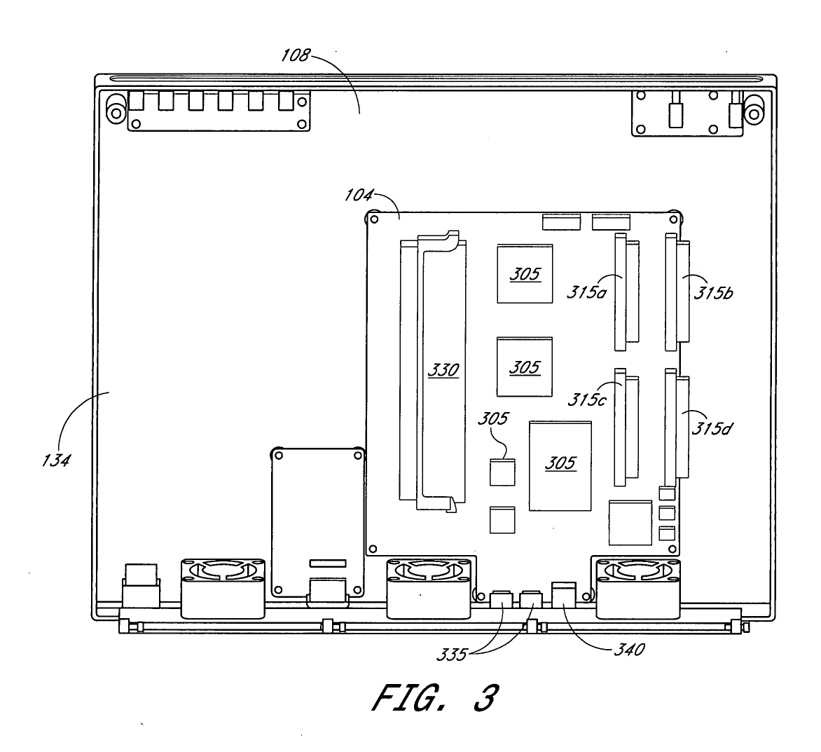

FIG. 3 illustrates in greater detail a layout of the RAID controller 104 within the top shell 108, according to one embodiment. The RAID controller 104 is secured to the top mounting surface 134, which comprises a generally flat platform upon which components may be positioned and secured. The RAID controller 104 comprises a RAID controller chipset 305, four hard drive connectors 315a through 315d, and a memory module 330. The RAID controller chipset 305 performs computations necessary for controlling the operation of the portable RAID device 100. The RAID controller chipset 305 is in communication with the memory module 330, which is random access memory (“RAM”) that stores information associated with the operation of the RAID controller 104. The RAID controller chipset 305 is also in communication with the hard drive connectors 315a through 315d. The hard drive connectors 315a through 315d may be connected via cable to the four hard drives' controller connectors 115a through 115d, respectively, thus allowing the RAID controller 104 to control the operation of the hard drives 102a through 102d. Additionally, the RAID controller chipset 305 is in communication with firewire ports 335 and a USB port 340, thus allowing the RAID controller 104 to communicate with a computer or computer network to which the portable RAID device 100 is attached. An opening may be formed through the hinge 112 to allow access to the ports 335 and 340 while the enclosure 106 is closed. A skilled artisan will appreciate, in light of this disclosure, that, in addition to or as alternative to firewire and USB, other types of connections may be supported, and other types of ports, such as serial ports, parallel ports, and the like, may be provided for the portable RAID device 100.

The RAID controller 104 may be enabled to control the portable RAID device 100 in accordance with one or more of several RAID levels, including, for example, RAID 0, RAID 1, RAID 3, RAID 5, and RAID 10. In this regard, the presence of four hard drives 102a through 102d within the portable RAID device 100 provides a distinct advantage over a RAID device with only two drives, as a two drive RAID device currently may operate according to RAID level 0 or 1 only.

As illustrated, the memory module 330 typically is a relatively bulky component, in that it extends out from the top mounting surface 114 a greater distance than do the other components of the RAID controller 104. Nevertheless, this bulkiness need not add to the width of the portable RAID device 100. This is because the memory module 330 may be positioned to line up with the gap 230 between the hard drives 102a through 102d. The gap 230 is also sufficiently large to contain power cables and plugs and hard drive cables and plugs. As such, the gap 230 may contribute to an efficient utilization of space that allows the portable RAID device 100 to maintain a shape similar to a laptop and dimensions only slightly larger than a typical laptop. For this reason, in a preferred embodiment, the hard drives 102a through 102d may be aligned as shown in FIG. 2, with their connectors facing inward, toward the middle of the bottom mounting surface 124. Such a configuration advantageously maximizes the size of the gap 230 while minimizing any space inefficiency that results from the presence of the gap 230. Alternatively, the hard drives 102a through 102d may be positioned with their connectors facing out, toward the bottom left wall 128 and the bottom right wall 132. Or, two of the hard drives 102a through 102d, such as, for example, the hard drive 102a and the hard drive 102c, may be positioned such that their connectors face a side wall, such as, for example, the bottom left wall 128, while two of the hard drives, such as, for example, the hard drive 102b and the hard drive 102d may be positioned such that their connectors face the middle of the bottom mounting surface 124. A skilled artisan will appreciate, in light of this disclosure, that the foregoing alternative layouts would essentially retain the shape and dimensions of the portable RAID device 100, but may result in slight space inefficiency.

Overall, the layout of components within the portable RAID device 100 allows the portable RAID device 100 to have relatively compact dimensions for a RAID device with four hard drives. In one preferred embodiment, the outside dimensions of the enclosure 106 are approximately 13.75 inches along a first dimension, 10.9 inches along a second dimension, and 1.9 inches along a third dimension. A skilled artisan will appreciate that a portable RAID device 100 may be designed with different overall dimensions while embodying the invention disclosed herein. For example, the first dimension may be within a range of 12 inches and 16 inches, within a range of 13 inches and 15 inches, or within a range of 13 inches and 14 inches. The second dimension may be within a range of 8 inches and 13 inches, within a range of 9 inches and 12 inches, or within a range of 10 inches and 11 inches. The third dimension may be within a range of 1.25 and 2.5 inches, within a range of 1.5 and 2.25 inches, or within a range of 1.75 and 2.0 inches.

The relatively compact dimensions of the portable RAID device 100 can be illustrated in comparison to the dimensions of typical hard drives. A hard drive typically has dimensions that are approximately 5.8 inches by 4 inches by 1 inch. In a 2×2grid pattern, the 5.8 inch measurement and the 4 inch measurement must be doubled to represent the absolute minimum dimensions required for an enclosure that houses four drives. Thus, the absolute minimum size for an enclosure holding four typical hard drives in a 2×2 pattern is 11.6 inches by 8 inches by 1 inch. No enclosure actually could achieve such a small size, because such a size would not leave room for mounting surfaces, connectors, cables, or anything else. Nevertheless, this theoretical absolute minimum size provides a basis for comparison. One basis for comparing the compactness of the overall portable RAID device 100 is to calculate a ratio of each outside dimension of the portable RAID device 100 with the absolute minimum dimension necessary to house the hard drives. Thus, for example, in one embodiment where a first outer dimension is 13.75 inches, a second outer dimension is 10.9 inches, and a third outer dimension is 1.9 inches, the ratios to the absolute minimum dimension follow: (1) 13.75 inches divided by 11.6 inches, or approximately 1.19, (2) 10.9 inches divided by 8 inches, or approximately 1.36, and (3) 1.9 inches divided by 1 inch, or approximately 1.9. Using this method for comparison for the alternative ranges disclosed in the preceding paragraph, the ratios may, with regard to the first dimension, be between 1.03 to 1.38, or 1.12 to 1.29, or 1.12 to 1.21. With regard to the second dimension, the ratios may be between 1.0 to 1.625, or 1.125 to 1.5, or 1.25 to 1.375. With regard to the third dimension, the ratios may be between 1.25 to 2.5, or 1.5 to 2.25, or 1.75 to 2.0.

Additionally, the total external surface area of the portable RAID device 100 may be compared to the sum of the external surface areas of the four hard drives. Assuming that the dimensions of a typical hard drive are as previously disclosed, the external surface area of a typical hard drive is approximately 66 square inches. The sum of the external surface areas of four such drives is approximately 264 square inches. In one embodiment, where the external dimensions of the portable RAID device are approximately 13.75 inches, 10.9 inches, and 1.9 inches, respectively, the total external surface area of the portable RAID device 100 is approximately 393 square inches. Thus, in this embodiment, the surface area ratio is approximately 1.62. Alternatively, the surface area ratio may fall within any of the ranges of 0.92 to 2.12, or 1.15 to 1.84, or 1.29 to 1.56.

An artisan will appreciate in light of the foregoing that if hard drives become available with substantially changed dimensions, a portable RAID device 100 that incorporates such hard drives may have substantially different dimensions than those disclosed herein. A skilled artisan would be enabled, based on this disclosure to determine appropriate modifications in dimensions to the portable RAID device 100 while remaining true to the principles disclosed herein. In particular, a skilled artisan would appreciate that a compact, easy-to-use layout would achieve relative ratios consistent with the disclosure of the preceding two paragraphs. It is anticipated that changes in hard drive dimensions may occur, but it is intended that any portable RAID device 100 that adheres to the principles of layout and the ratios of the preceding two paragraphs is within the scope of the invention, even though the dimensions of the portable RAID device 100 may be substantially different from the dimensions disclosed herein.

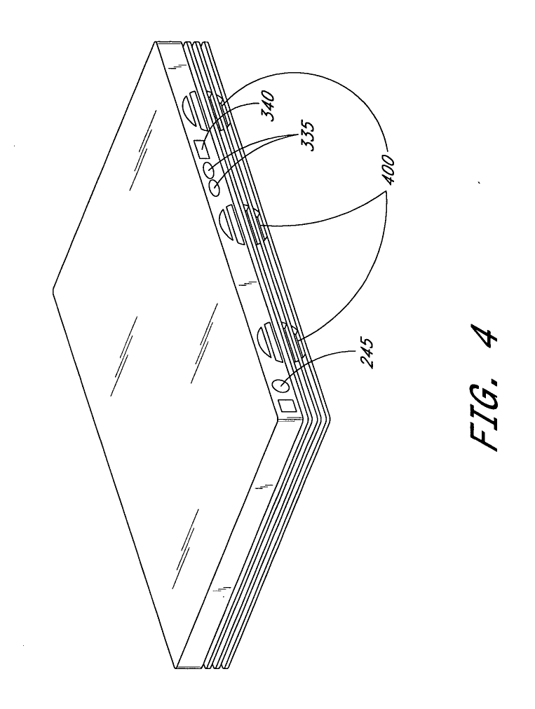

FIG. 4 illustrates the portable RAID device 100 in a closed position from a rear perspective. As illustrated, the firewire ports 335, the USB port 340, and the power port 245 are each accessible to a user from the outside such that a user may connect the portable RAID device 100 to a computer or computer network and to a source of power. An artisan will readily appreciate in light of this disclosure that standard cables may be used for this purpose. As will also be appreciated by a skilled artisan in light of this disclosure, alternative connections, such as, for example, serial ports or parallel ports, may be supported. In addition, the portable RAID device 100 may include an 802.11 or other wireless Local Area Network (“LAN”) interface to support a wireless data connection to a user computer. Also illustrated, fan grates 400 allow for proper ventilation of the portable RAID device 100.

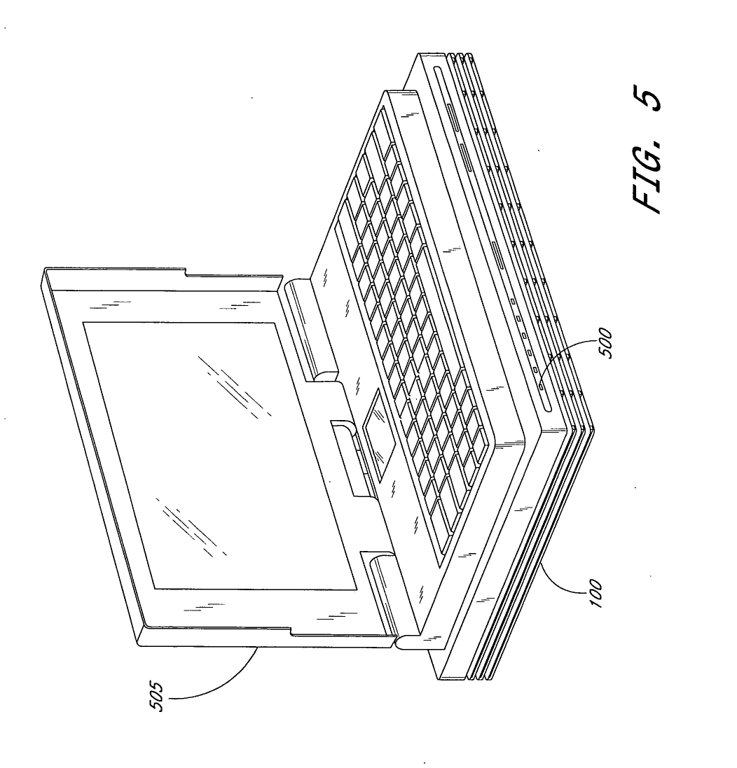

FIG. 5 illustrates the portable RAID device 100 in a closed position from a front view, with a laptop computer resting on top of the portable RAID device 100. As shown, the portable RAID device 100 has a number of LEDs 500 on its front face. The LEDs 500 display status information concerning the operation of the portable RAID device 100. As has been explained, advantageously the portable RAID device 100 may resemble a laptop computer in its shape and dimensions. As illustrated, the portable RAID device 100 is slightly larger than a typical laptop. As shown, the shape and dimensions of the portable RAID device 100 allow it to be positioned, while in use, underneath a typical laptop computer 505, such that the laptop computer 505 may rest on the portable RAID device 100. Advantageously, the fan grates 400, illustrated in FIG. 4, are positioned to the rear of the portable RAID device 100, such that the placement of the laptop computer 500 on top of the portable RAID device 100 does not interfere with proper airflow and ventilation within the portable RAID device 100.

It is contemplated that in some embodiments, the portable RAID device 100 may specifically be designed to work with one or more specific models of laptop computer. In such cases, the laptop and portable RAID device may share a common power supply or power cable, and may communicate with each other using proprietary connections and/or protocols.

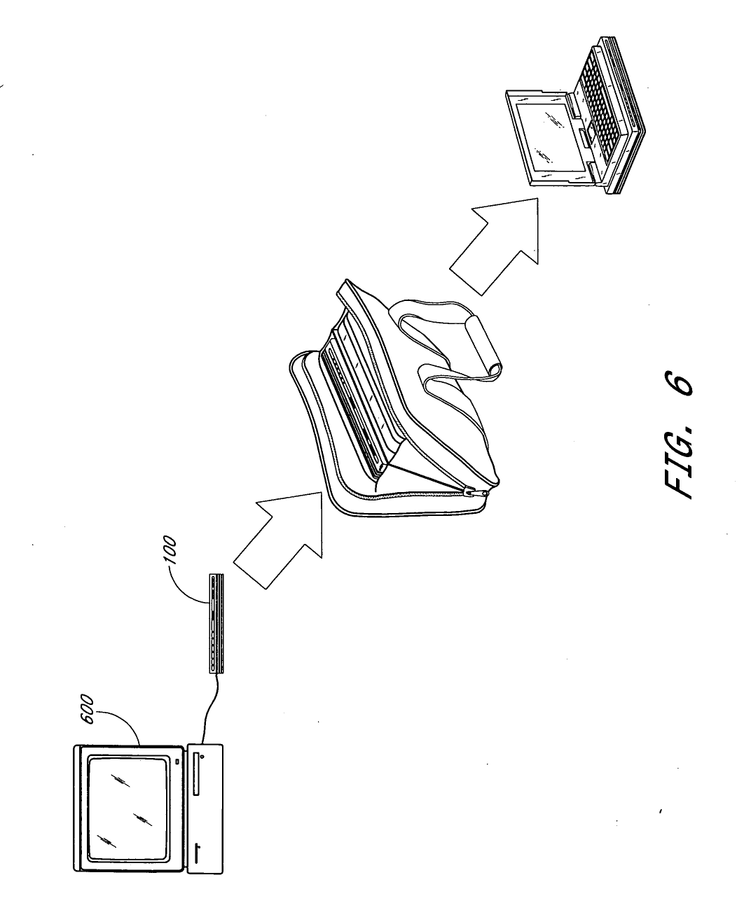

FIG. 6 illustrates another advantage of the shape and dimensions of the portable RAID device 100. Specifically, as shown the shape and dimensions of the portable RAID device 100 allow for ease of use and transportability of data stored within the portable RAID device 100. As shown with respect to desktop computer system 600, the portable RAID device 100 may be easily connected to the desktop computer system 600. A user may use the portable RAID device 100 as a permanent storage device for some or all of his or her data. For example, a user may store data that he or she often uses while traveling, such as customer data that a traveling salesman frequently accesses, on the portable RAID device 100. By connecting the portable RAID device 100 to the desktop computer system 600, which may be located at the user's office, the user may directly manipulate the data, without needing to transfer data, such as by using a copy command. Alternatively, a user may connect the portable RAID device 100 to the desktop computer system 600 and transfer vast amounts of data to the portable RAID device 100 for the purpose of taking the data with him or her on a trip.

After a user disconnects the portable RAID device 100 from the desktop computer system 600, the portable RAID device 100 is easy to carry in standard carry-on sized baggage, such as, for example, a laptop case 605. Indeed, as illustrated, the shape and dimensions of the portable RAID device 100 advantageously allow for the portable RAID device 100 to be carried in the same laptop case 605 with a typical laptop computer 500. On the other hand, a user would not typically be able to easily carry both a laptop computer and a tower shaped RAID device in the same laptop case 605. Because of this advantage, traveling users that need access to vast amounts of data stored on RAID compliant technology will appreciate the shape and dimensions of the portable RAID device 100. A user may transport the device and connect it to another computer, such as a laptop computer 500. A skilled artisan will appreciate, in light of this disclosure, that a user may connect the portable RAID device 100 for any number of reasons, and that the portable RAID device 100 is not intended to be used solely during travel. For example, a user may use the portable RAID device 100 to work on data stored thereon from both his or her office computer and his or her home computer.

FIG. 6 also illustrates that, according to one embodiment, the portable RAID device 100 provides external storage for a computer or network node. That is, the portable RAID device 100 typically rests outside of a computer to which it is connected, such that the portable RAID device 100 is not within an enclosure that houses a Central Processing Unit, a video card, a motherboard, or the like. Additionally, the portable RAID device 100 typically does not have a display screen, a keyboard, or other peripherals typically associated with a desktop or laptop computer.

The portable RAID device 100 may be used in combination with software installed on each computer to which it connects. In one embodiment, the software includes a driver that allows a computer to recognize and communicate with the portable RAID device 100. The software may include a feature that allows a user to associate the portable RAID device 100 with a particular drive designation on a host computer. Additionally, the software may include a feature that allows a user to partition the storage of the portable RAID device 100 into logical storage areas. The software may associate each logical storage area with a particular computer, or with a particular user, or the like, such that only the associated computer or user may have access to each logical storage area. The software may include a security feature that disables the portable RAID device 100 so that it cannot be accessed when it is connected to a computer that is not recognized by the portable RAID device 100, or when an unknown user logs on to the computer. This configuration advantageously assists in the protection of confidential information.

In one embodiment, the portable RAID device 100 includes software or firmware that encrypts the data stored on the portable RAID device 100. Upon being connected to a computer, the portable RAID device 100 may prompt the user for an encryption key for unencrypting the data stored on the portable RAID device 100. Advantageously, this embodiment prevents an unauthorized user's use of the data on the portable RAID device 100, even if the unauthorized user takes the hard disk drives out of the portable RAID device 100 and connects them to another RAID controller without an encryption feature. This is because once the data has been encrypted, it cannot be read until it has been unencrypted.

In one embodiment, the portable RAID device 100 includes a write once, read many feature. When this feature is enabled, the portable RAID device 100 allows writing new files to the portable RAID device 100, but does not allow overwriting existing files. In this mode, the portable RAID device 100 may keep a copy of every version of a document. In this embodiment, when a user creates a new version of a file, the old version and the new version are stored on the portable RAID device 100. In one embodiment, the portable RAID device 100 contains hardware, software, or firmware toggles to allow a user to turn this feature on or off.

The foregoing disclosure describes certain embodiments of the portable RAID device 100 disclosed herein. A skilled artisan will appreciate that not all features described herein need be included in every embodiment of the portable RAID device 100. A skilled artisan will further appreciate that not every advantage of the portable RAID device 100 will necessarily apply to every embodiment of the portable RAID device 100. This disclosure, therefore, is intended to provide the reader with an understanding of several possible embodiments of the portable RAID device 100, but is not intended to limit the invention disclosed herein to any particular described embodiment. The claims, not this disclosure, define the invention, whether the claims were originally presented, added, or amended.

1. A portable RAID device comprising:
four hard disk drives, including a first hard disk drive, a second hard disk drive, a third hard disk drive, and a fourth hard disk drive, each hard disk drive having a rear portion with a connector for receiving a cable;
a RAID controller connected via cable to the connectors of the four hard disk drives, the RAID controller capable of controlling the four hard disk drives as a RAID array;
an input/output port configured to connect the portable RAID device to a computer such that the portable RAID device is able to provide external data storage for the computer; and
an enclosure enclosing the four hard disk drives and the RAID controller, wherein the four hard disk drives are arranged in a 2 by 2 pattern and positioned within a common horizontal plane.

2. The portable RAID device of claim 1, wherein the rear portion of the first hard disk drive runs substantially parallel to and faces the rear portion of the second hard disk drive and the rear portion of the third hard disk drive runs substantially parallel to and faces the rear portion of the fourth hard disk drive.

3. The portable RAID device of claim 2, wherein the RAID controller is capable of controlling the four hard disk drives according to at least RAID level 5.

4. The portable RAID device of claim 2, wherein the enclosure is generally flat and configured to support a laptop computer on its top surface.

5. The portable RAID device of claim 2, wherein the enclosure is substantially rectangular, having a first dimension, a second dimension, and a third dimension, wherein the first dimension is at least as large as the second dimension and is larger than the third dimension and measures between 12 inches and 16 inches.

6. The portable RAID device of claim 5, wherein the second dimension is larger than the third dimension and measures between 8 inches and 13 inches.

7. The portable RAID device of claim 6, wherein the third dimension measures between 1.25 inches and 2.5 inches.

8. The portable RAID device of claim 2, wherein the enclosure is substantially rectangular, having a first dimension, a second dimension, and a third dimension, wherein the third dimension is smaller than both the first dimension and the second dimension and measures between 1.25 inches and 2.5 inches.

9. The portable RAID device of claim 2, wherein the enclosure is substantially rectangular, having a first dimension, a second dimension, and a third dimension, wherein the ratio of the first dimension of the enclosure to twice the corresponding dimension of the first hard disk drive is between 1.03 and 1.38.

10. The portable RAID device of claim 8, wherein the ratio of the second dimension of the enclosure to twice the corresponding dimension of the first hard disk drive is between 1.0 and 1.625.

11. The portable RAID device of claim 10, wherein the ratio of the third dimension of the enclosure to the corresponding dimension of the first hard disk drive is between 1.25 and 2.5.

12. The portable RAID device of claim 1, wherein the ratio of the surface area of the enclosure to the sum of the surface areas of the four hard disk drives is between 0.92 and 2.12.

13. The portable RAID device of claim 2, wherein the ratio of the surface area of the enclosure to the sum of the surface areas of the four hard disk drives is between 0.92 and 2.12.

14. The portable RAID device of claim 1, wherein the enclosure has substantially the same size and external dimensions as a standard laptop computer.

15. The portable RAID device of claim 1, wherein the portable RAID device lacks a keyboard and a display screen.

16. A portable RAID device comprising:
an enclosure comprising a first shell and a second shell;
a RAID controller secured to the first shell, the RAID controller configured to control at least four hard disk drives according to at least one RAID level, the RAID controller comprising a circuit board with a first set of components secured to the circuit board and extending out from the circuit board at least a first distance and a second set of components secured to the circuit board and extending out from the circuit board at least a second distance, wherein the first distance is larger than the second distance; and
four hard disk drives secured to the second shell and arranged in a first column of two hard disk drives and a second column of two hard disk drives with a gap between the first column and the second column, the gap being aligned and sized such that when the first shell and the second shell are brought together to close the enclosure, the first set of components are positioned within the gap such that the first distance that the first set of components extend out from the circuit board does not contribute to the external dimensions of the enclosure.

17. The portable RAID device of claim 16, wherein the enclosure is substantially rectangular, having a first dimension, a second dimension, and a third dimension, the third dimension being smaller than both the first dimension and the second dimension and measuring between 1.25 and 2.5 inches.

18. The portable RAID device of claim 16, wherein the enclosure is generally flat and configured to support a laptop computer on its top surface.

19. The portable RAID device of claim 16, wherein the enclosure has substantially the same shape and dimensions as a standard laptop computer.

20. The portable RAID device of claim 14, wherein the portable RAID device lacks a keyboard and a display screen.
